(19) United States
(12) Patent Application Publication
(10) Pub. No.: US 2009/0133299 A1
(43) Pub. Date: May 28, 2009

(54) Message display balloon

(76) Inventor: Zachary Blackwell, Rosamond, CA (US)

Correspondence Address: Randall L. Owen, 573 Fairfield Road, Simi Valley, CA, 93065, US

(21) Appl. No.: 12/288,820

(22) Filed: Oct. 23, 2008

Related U.S. Application Data
(60) Provisional application No. 61/004,436, filed on Nov. 27, 2007.

(51) Int. Cl. G09F 21/06; F21V 21/30; G09G 3/14

(52) U.S. Cl. 40/212; 362/35; 345/46

(57) ABSTRACT

A dynamic messaging system comprises a balloon, a lighting array disposed within the balloon and further comprising a plurality of light-emitting diodes, a power source connected to the lighting array, and a means for rotating the lighting array within the balloon. In a first preferred embodiment, the lighting arrays includes a plurality of light-emitting diodes that are capable of generating monochrome visible light, thereby providing simple graphics and alphanumeric messages. In a second preferred embodiment, the lighting array includes a plurality of light-emitting diodes are capable of generating colored visible light, thereby providing complex graphics and messages. In a third embodiment, the lighting array includes a plurality of ultraviolet laser diodes that generate graphics and messages on an inner, flourescent-coated surface of the balloon.

### CROSS-REFERENCE TO RELATED PATENT APPLICATIONS

This application claims priority to U.S. Provisional Application 61/004,436 filed Nov. 27, 2007, incorporated herein by reference in its entirety.

### BACKGROUND OF THE INVENTION

1. Field of the Invention

The present invention relates to messaging devices and, more particularly, to a message display balloon containing an electronic control system for displaying dynamic messages.

2. Description of the Prior Art

The idea of using electronics to enhance the display function of a balloon is not new. U.S. Pat. No. 2,383,390 to Jacobs used an electric light to illuminate a graphic of a flag inside of a balloon. This invention was created in anticipation of the celebration of troops returning home at the end of WWII. The message display balloon of the present invention has an advantage over Jacobs, balloon in that the graphic inside of the balloon is under software control. This gives the message or graphic the advantage of not only being dynamic, but it can also be personalized for a specific person or occasion.

Other related prior art includes U.S Pat. No. 6,856,303 to Kowalewski and U.S Pat. No. 6,037,876 to Crouch, which are two examples of many inventions that use the persistence of vision effect to create messages and graphics in space. In Kowalewski, the persistence of vision effect is used to create a display medium to display data such as the time and date. Similarly, Crouch uses a ceiling fan as the spinning member to mount an array of lights to generate messages and graphics in space.

The combination of a dynamic messaging system with a balloon can improve the flexibility and entertainment value of the displayed messages. More particularly, messages can be pre-programmed for various special occasions, such as birthdays or anniversaries, and stored for later use. Multiple messages can also be combined to create more complex communications in applications ranging from product promotions to political campaigns. In addition, the balloon that contains the dynamic messaging system can be used to elevate and attract attention to the message, thereby increasing the impact of the message content.

Accordingly, there is a need for a message display system in which a dynamic massage generation system is encapsulated within a conventional balloon.

### SUMMARY OF THE INVENTION

The present invention is directed to a message display balloon, in which a dynamic message generation and display system that is encapsulated within a conventional balloon and is light enough to allow that balloon to float when filled with helium.

In a first exemplary embodiment of the present invention, a message display balloon includes a dynamic message generation system that uses a light-emitting diode (LED) array. A message is generated inside the balloon using a stored computer software program to turn on and off the individual LEDS as the LED array is rotated within the balloon. The persistence of vision effect of the human eye results in the blending of these rapid changes in illumination into a single perceived message image. More particularly, when the LED array travels along a circular path within the balloon, the LEDS are pulsed on and then off periodically, the persistence of vision effect causes multiple lighted columns to be seen by the human and the dynamic message effectively “painted” in space.

A key advantage of using the led array to generate a display medium in space is its low weight design that will allow the balloon lifting this display apparatus to remain buoyant. In addition, the LED array is very low cost, as are the components needed to power and drive the individual LEDs. Of course, the messages generated by this first embodiment, while dynamic, are limited to single color (monochrome) alphanumeric text.

Thus, in a second preferred embodiment of the present invention, the LED array contains seven separate LED components each with the ability to display the primary colors red, green, and blue. These three colors can be combined to create many combinations of colors, and therefore provide the ability to generate more complex text and graphics. The method for providing power to the LED array and its associated electronic components is also simpler and improves the measurement accuracy of its rotation within the balloon.

In a third embodiment of the present invention, the LED array is replaced by two ultraviolet (UV) laser LED arrays that are attached to opposite ends of the rotating arm within the balloon. One of the UV LED arrays contains three laser diodes and the other contains four laser diodes. The inner surface of the balloon is coated with a fluorescent powder that reacts to the UV light generated by the laser diodes. This allows the dynamic message to be “painted” directly onto the inner surface of the balloon, thereby improving the contrast and brightness of the displayed message.

Therefore an object of the present invention is to improve the level attention given to a dynamic message or display by suspending it within a floating balloon.

Another object of the present invention is to provide a dynamic messaging system that displays monochrome graphics and messages.

Still another object of the present invention is to provide a dynamic messaging system that displays color graphics and messages.

Yet another object is to provide a dynamic messaging system that is easy to assemble and deploy.

An additional object is to provide a dynamic messaging system that uses simple and low-cost components.

Further features and advantages of the present invention will be appreciated by a review of the following detailed description of the preferred embodiments taken in conjunction with the following drawings.

### BRIEF DESCRIPTION OF THE DRAWINGS

The present invention may be best understood by referring to the following detailed description of the preferred embodiments and the accompanying drawings, wherein like numerals denote like elements and in which:

FIG. 1A is a hybrid cutaway and perspective view of a first preferred embodiment of a message display balloon 100 constructed in accordance with the present invention;

FIG. 1B is a front view of message display balloon 100 in operation shown from a distance;

FIG. 1C is an isometric cutaway view of concentric tubes 121, logic power wires 116, and a cutaway of support clip 117, balloon support 118, and balloon 101 (shown as dashed line)of the first preferred embodiment;

FIG. 1D is an isometric view of the persistence of vision effect for the first preferred embodiment;

FIG. 1E is an isometric view of a message painted in space for the first preferred embodiment;

FIG. 1F is a diagram showing how memory is mapped inside the microcontroller of the first preferred embodiment;

FIG. 1G is a diagram showing the electronic hardware configuration including the hardware internal to the microcontroller of the first preferred embodiment;

FIG. 1H is a flow chart of the main software loop 600 for the first preferred embodiment;

FIG. 1I is a flow chart of the completed revolution interrupt service routine 700 for the first preferred embodiment;

FIG. 1J is a flow chart of the pixel column data interrupt service routine 800 for the first preferred embodiment;

FIG. 1K is a flow chart of the USB interrupt service routine 900 for the first preferred embodiment;

FIG. 1L is a simple front view showing the first preferred embodiment connected to a personal computer before a balloon is installed;

FIG. 1M is a simple front view showing the first step for installing a balloon in the first preferred embodiment;

FIG. 1N is a simple front view showing the second step for installing a balloon in the first preferred embodiment;

FIG. 1O is a simple front view showing the third step for installing the balloon in the first preferred embodiment;

FIG. 1P is a simple front view showing the fourth step for installing the balloon in the first preferred embodiment;

FIG. 2A is a combination cut-away and perspective view of a second preferred embodiment of a message display balloon 200 constructed in accordance with the present invention;

FIG. 2B is a front view of the second preferred embodiment in operation;

FIG. 3A is a combination of cut-away and perspective views of a third preferred embodiment of a message display balloon 300 constructed in accordance with the present invention;

FIG. 3B is a front view of the even row and odd row LED arrays of the third preferred embodiment positioned side-by-side;

FIG. 3C is a front view of the third preferred embodiment in operation;

FIG. 3D is an isometric view showing the method for displaying the message in the third preferred embodiment with the odd LED array in front; and

FIG. 3E is an isometric view showing the method for displaying the message in the third preferred embodiment with the even LED array in front.

### DETAILED DESCRIPTION OF THE PREFERRED EMBODIMENTS

The following exemplary discussion focuses on a message display balloon containing an electronic display and control system for displaying dynamic messages within a floating balloon.

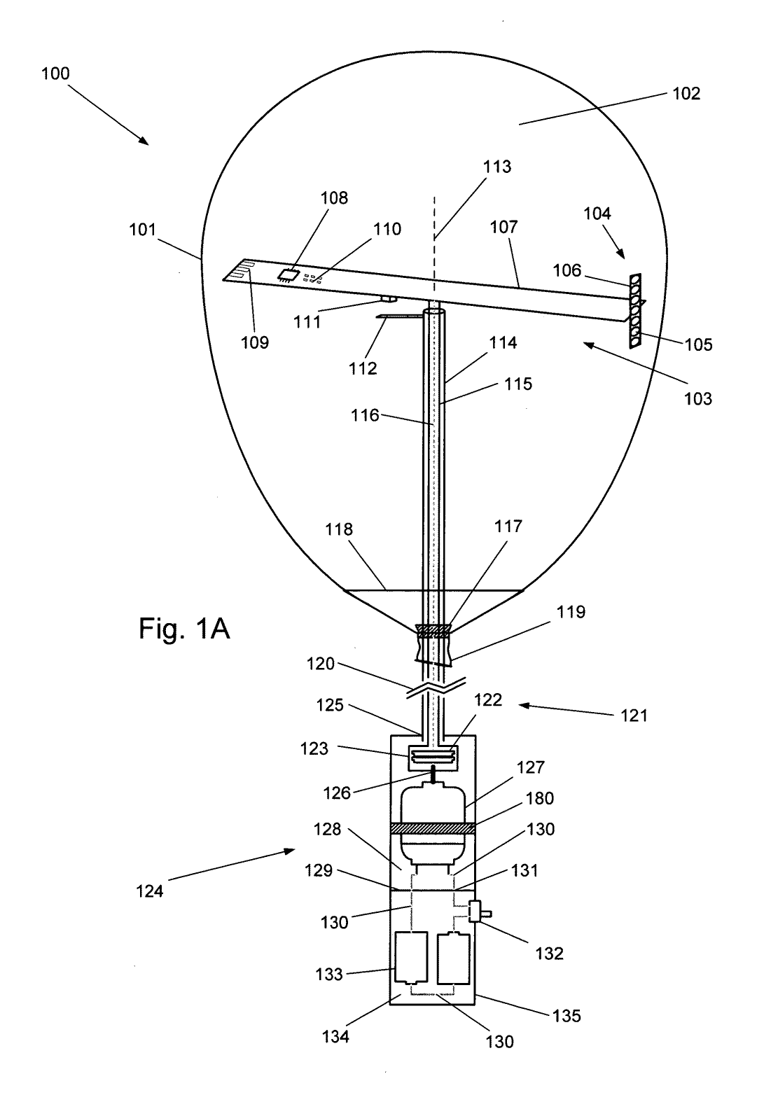

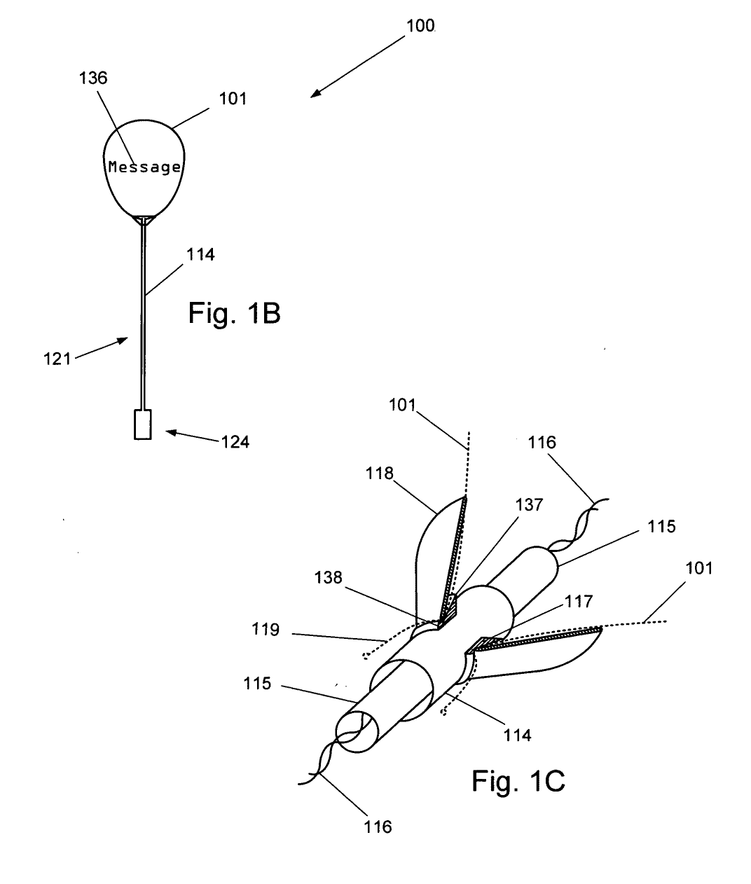

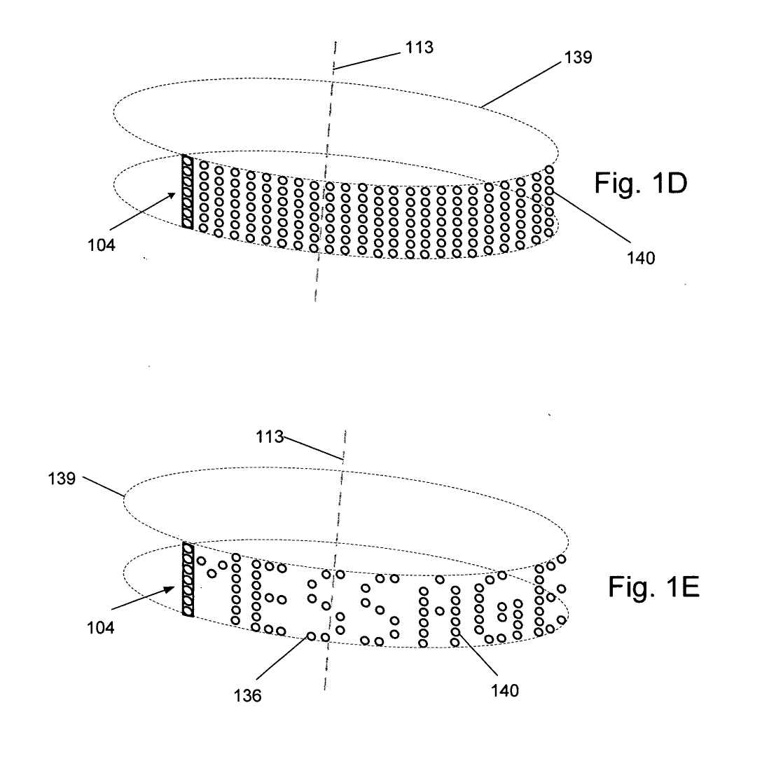

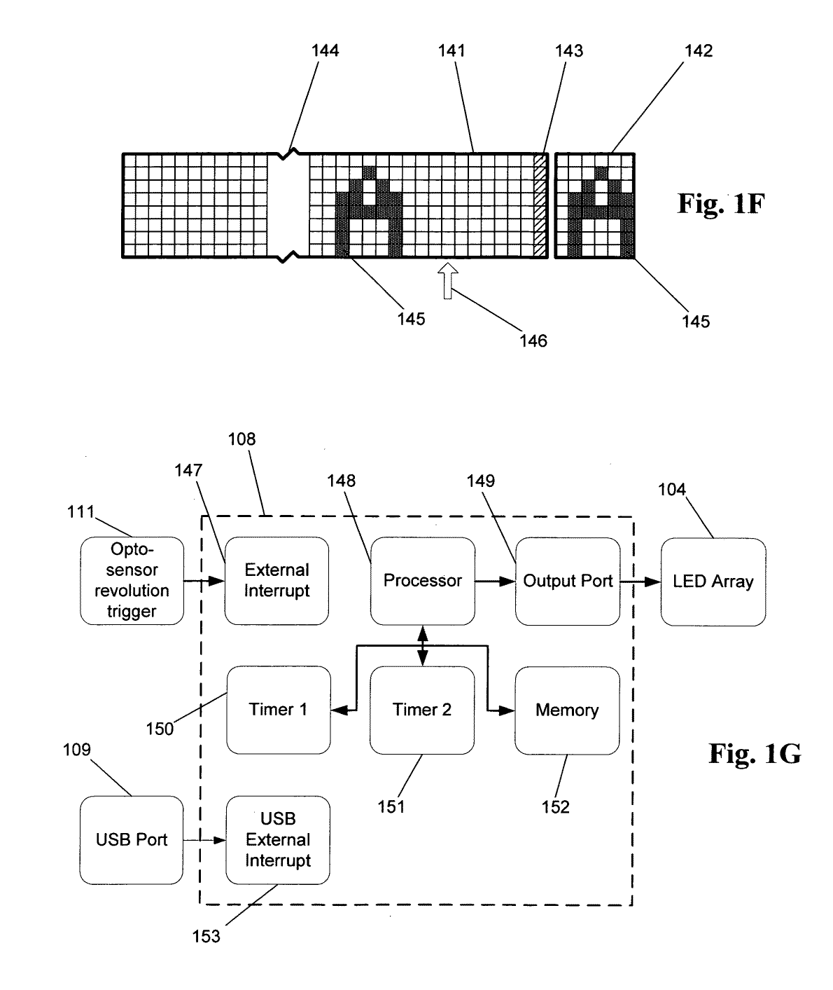

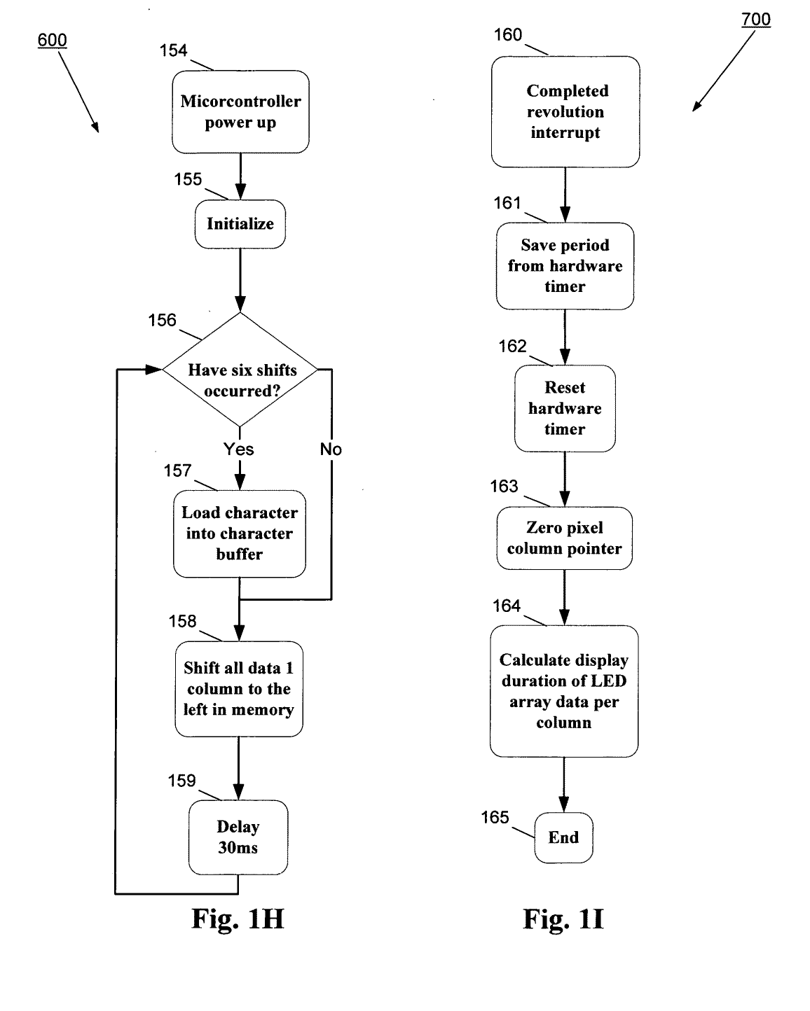

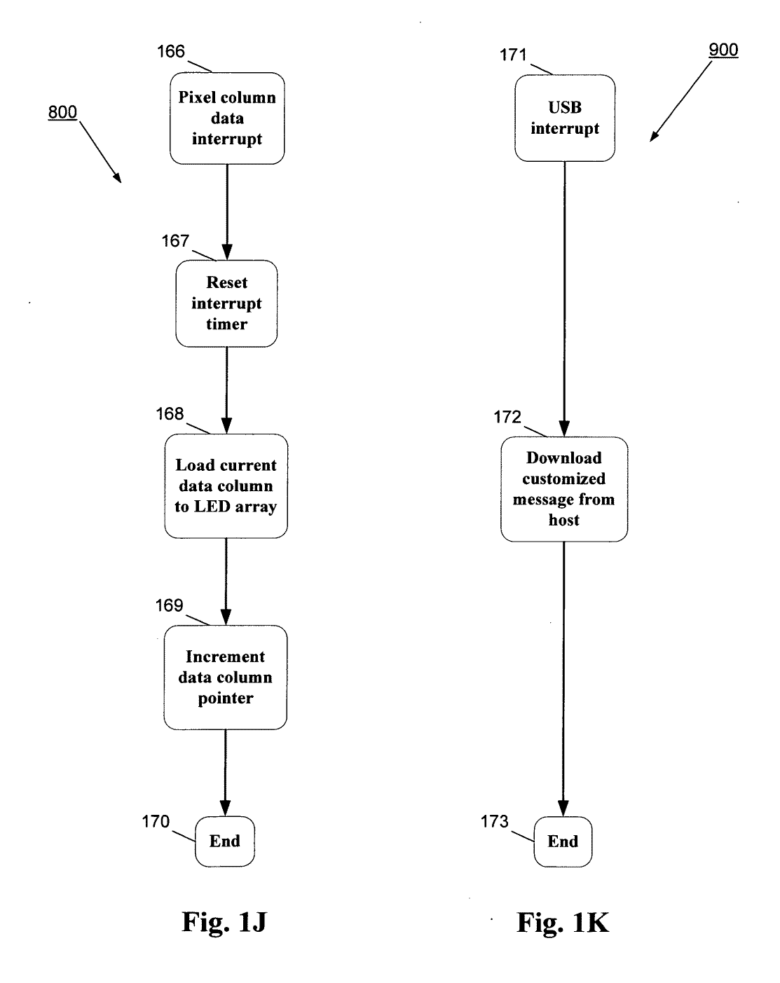

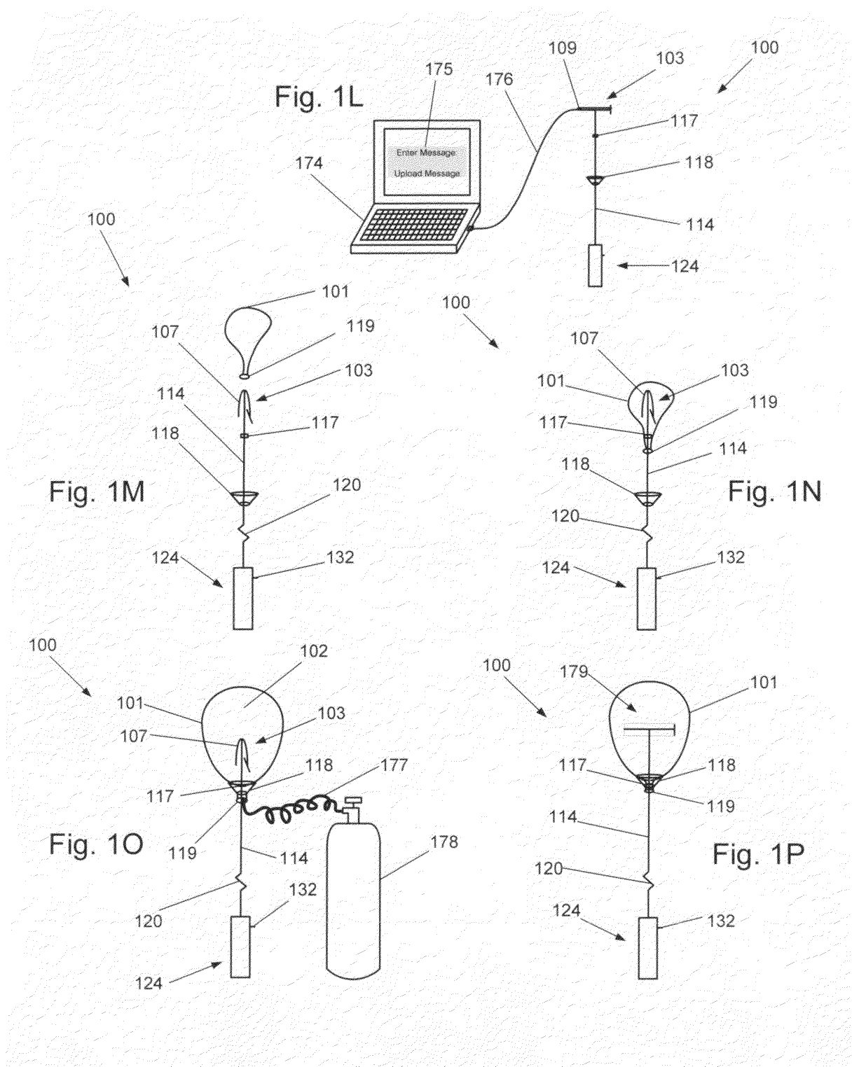

FIG. 1A shows a hybrid cut-away and perspective view of a first preferred embodiment of a message display balloon 100 constructed in accordance with the present invention. Message display balloon 100 is comprised of a balloon 101, which is inflated with pressurized helium 102. Balloon 101 is connected to a base assembly 124 through a pair of concentric tubes 121 further comprised of an inner concentric tube 115 and an outer concentric tube 114. Balloon 101 encapsulates a display assembly 103. Display assembly 103 consists of a light-emitting diode (LED) array 104, a rotating arm 107, and other electronic components described in more detail below.

LED array 104 is comprised of seven LEDs 105 that are connected to a solid printed circuit board 106. Rotating arm 107 is constructed of flexible circuit board material, which allows it to be inserted into balloon 101 by bending to extreme angles without breaking. LED array 104 is soldered to rotating arm 107, and is oriented perpendicular to the latter's plane of rotation. At the end opposite of LED array 104 is a universal serial bus (USB) data connection point 109. USB data connection point 109 is constructed of exposed conductive circuit board traces that allow for a card-end type connector (not shown) to be clipped on to the end of rotating arm 107. On this same end of rotating arm 107 is a microcontroller 108, which is securely connected to the top of rotating arm 107. In close proximity to microcontroller 108 are a set of passive electronic components 110, including various resistors and capacitors that aid in the function of microcontroller 108 and LED array 104.

Positioned on the bottom of rotating arm 107 is an infrared reflective opto-sensor 111, the latter of which is a common off-the-shelf component known to those skilled in the art. Opto-sensor 111 is designed to detect when a reflective tab 112 is in close proximity, by emitting an infrared light and detecting the reflection. The light-emitting portion of opto-sensor 111 points downward towards reflective tab 112, in close enough proximity to allow the reflected light to be detected.

All of the components that make up display assembly 103 are chosen to be of a predetermined dimension and material in order to keep the weight down and allow positive buoyancy for balloon 101. Further more the components of display assembly 103 are placed in predetermined locations so that when spun about an axis of rotation 113 the sum of component centrifugal forces remain balanced.

Display assembly 103 is mounted on top of inner concentric tube 115. Inner concentric tube 115 is directly connected to a rotating battery case 123 which, in turn, is directly connected to an electric motor shaft 126 inside of a base assembly 124. The combination of display assembly 103, inner concentric tube 115, and rotating battery case 123 is all free to spin about axis of rotation 113. Inside of rotating battery case 123 are a set of logic batteries 122, the latter connected to a pair of logic power wires 116 that passes through inner concentric tube 115 and are connected, and provide electrical power, to microcontroller 108 and electronic components 110.

Continuing with (FIGS. 1A and 1C), outer concentric tube 114 guides and supports inner concentric tube 115, while the latter is rotating. Outer concentric tube 114 is attached to balloon 101 and base assembly 124 and is not free to rotate. It should be noted that concentric tubes 121 are made of a material with low friction coefficient such as Polytetrafluoroethylene (PTFE), allowing inner concentric tube 115 to easily rotate within outer concentric tube 114.

At the point where balloon 101 meets outer concentric tube 114 are two components, a support clip 117 and a balloon support 118, that supports and seals balloon 101. Support clip 117 (shown in detail in FIG. 1C) is further comprised of a beveled ring 137 with a lip 138 at its narrow end. Clip 117 is positioned around, and fastened to, outer concentric tube 114. A balloon opening 119 passes over the outside of the support clip 117 (The cutaway profile of Balloon 101 is shown in FIG. 1C as a bold dashed line). Balloon support 118 is a cone-shaped structure with an opening at both ends. Balloon support 118 passes over the outside of balloon opening 119 and is slid up until the narrow end of balloon support 118 pushes past lip 138 of support clip 117, thereby sealing balloon 101.

As with display assembly 103, concentric tubes 121, logic power wires 116, support clip 117, and balloon support 118 are all of a predetermined weight that will not overcome the positive buoyancy of balloon 101 when filled with helium 102. Concentric tubes 121 are of an arbitrary length 120 but are restricted such that they still allow balloon 101 to float.

Outer concentric tube 114 is fastened to a base outer wall 135 at a location 125. Note that base assembly 124 is divided by a pressure dividing wall 129 into a pressurized chamber 128 and an un-pressurized chamber 134. Pressurized chamber 128 contains an electric motor 127 and is a continuation of the helium volume inside balloon 102 because they are connected by outer concentric tube 114. Electric motor 127 is held in place relative to base assembly 124 by a motor support clip 180. A set of motor wires 130 are attached to electric motor 127 and then pass through sealed wired penetrations 131 in pressure dividing wall 129. Inside of un-pressurized chamber 134 is a set of motor batteries 133 and a switch 132 for turning electric motor 127 on and off.

Referring now to FIGS. 1B-1F, the operation of the first embodiment of the present invention is disclosed. FIG. 1B is a front view of the first preferred embodiment of the message display balloon 100 in operation, and where base 124, concentric tubes 121, and balloon 101 are shown similar to a conventional balloon setup. Balloon 101 is free floating, and is tethered to the weight of base 124 by concentric tubes 121. Inside of balloon 101 a dynamic message 136 is displayed, the latter of which can be changed or personalized for any occasion.

Message 136 inside is generated using LED Array 104 and the persistence of vision effect 140, an example of which is shown in FIGS. 1D and 1E. Persistence of vision effect 140 is based on limitations in the speed of the human eye to process changes in light, which results in the blending of rapid changes into a single perceived image. The single array 104 of this embodiment coupled with persistence of vision effect 140 provides a light weight display medium that allows balloon 101 to remain buoyant while displaying message 136.

As shown in FIG. 1D, when LED Array 104 travels along a circular path 139, and all the LEDs are pulsed on and then off periodically, the persistence of vision effect 140 causes multiple lighted columns to be seen by the human eye. As shown in FIG. 1E, when specific LEDs in LED array 104 are turned on or off at specific points along circular path 139, a message or graphic 136 is effectively “painted” in space.

Referring briefly back to FIG. 1A, note all of the components inside balloon 101 and base assembly 124 are externally visible. Display assembly 103 is mounted to inner concentric tube 115, which is, in turn, mounted to rotating battery case 123 adjacent to electric motor output shaft 126 located inside base 124. When motor switch 132 is turned on, power from motor batteries 133 travels through motor wires 130, thereby activating electric motor 127.

The rotation of electric motor output shaft 126 causes rotating battery case 123, inner concentric tube 115 and display assembly 103 to likewise rotate. Electric motor 127 will rotate at the maximum rotational velocity that electric motor batteries 133 are capable of driving. A software program 600 executed by microcontroller 108 (explained later in detail) generates the timing signals needed to produce displayed message 136. This means that the exact rotational speed of display assembly 103 is not critical, as long as it is fast enough for persistence of vision 140 to take effect.

Looking briefly at the mechanical design of message display balloon 100, we focus on the concentric tubes 121, which are shown in detail in (FIGS. 1A and 1C). The reason for choosing concentric tubes 121 is the benefit of moving the weight of the heaviest components to base 124. In particular, electric motor 127 and logic batteries 122 are two components that have considerable weight and are moved to base 124 in the first preferred embodiment. With the weight of these components in base 124, balloon 101 will be able to float. Moreover, since batteries 122 that power display assembly 103 are in base 124, it becomes necessary to run logic power wires 116 up the inside of the inner concentric tube 115.

Because of oscillations that develop while message display balloon 100 is in operation, it is necessary to have a support 118 that will hold balloon 101 in a steady position relative to display assembly 103 that is spinning inside. Without support 118, balloon 101 would wobble out of control and eventually display assembly 103 would hit the inside surface of balloon 101. Balloon support 118 also seals off balloon opening 119 when it is clipped into support clip 117.

As mentioned earlier, the timing of LED array 104 is controlled by software program 600 executed by microcontroller 108, using the time period of rotating arm 107. This time period is clocked using infrared reflective opto-sensor 111, and reflecting tab 112. Opto-sensor 111 is mounted to the bottom of rotating arm 107 and spins with the rest of display assembly 103. Reflecting tab 112 is connected to outer concentric tube 114, which is, in turn, connected to balloon 101 and base 124, the latter two of which are not free to spin. With each revolution of rotating arm 107, infrared reflective opto-sensor 111 passes over reflecting tab 112, causing opto-sensor 111 to send a signal to microcontroller 108 indicating that a revolution has been completed by display assembly 103. Microcontroller 108 tracks the time duration of each revolution and uses this duration for message timing as will be explained below.

Referring now to FIGS. 1H through 1K, the flow charts for a software program 600 executed by microcontroller 108 software is now discussed. Software program 600 and its supporting interrupts have five key functions, including: processing message 136; shifting message 136 through a display memory 141; updating the data on LED array 104; tracking the period of each revolution of display assembly 103; and downloading customized messages via USB port 109.

Before explaining the operation of software program 600, memory architecture used by software program 600 will first be explained using (FIG. 1F) and (FIG. 1G).

FIG. 1F is a graphical representation of a portion of microcontroller's 108 internal memory 152. Contained within internal memory 152 are two portions, including a character buffer 142 and display memory 141. Display memory 141 is the memory portion that will be directly copied when LED array 104 sweeps along its path 139 (FIG. 1E) and paints a message 136 in space. In the first preferred embodiment, display memory 141 is 8 bits tall and 128 bits wide. Location 144 of FIG. 1F denotes the memory that is not shown in this figure. A first pixel column 143 of display memory 141 is shown in FIG. 1F. Note that because there are only seven LEDs in LED array 104, only the first 7 bit rows of all of display memory 141 are being used. A character buffer 142 is an 8 bit tall and 6 bit wide memory that acts as a staging area for display memory 141. A character map 145 is loaded into character buffer 142 and will be shifted into display memory 141 as will be explained below. Note that the dark spaces in each character pixel map 145 denote a logical 1 in memory which correlates to an LED being turned on. Similarly, the white spaces denote a logical 0, which correlates to the LEDs in LED array 104 being turned off.

In this embodiment, software function 600 is responsible for loading character map 145 into character buffer 142, shifting character map 145 into display memory 141, and then managing how that data is copied to LED array 104. Each time a shift takes place, each pixel data column will move into the pixel column to the left. The column that is shifted out of the left of character buffer 142 will be shifted into pixel column one 143 of display memory 141. The pixel column that is pushed out of the left of display memory 141 is not saved. Shifting the data to the left one column periodically will cause the pixels in the display to scroll, and thus scrolling messages 136 are generated.

Continuing now with FIG. 1H, the flow chart of a main software loop 600 for the first preferred embodiment is discussed. Starting with step 154, microcontroller 108 is powered up for the first time and is in its power up state. Processing continues with step 155, in which the functions and state of microcontroller 108 are initialized. In the first preferred embodiment, the key hardware functions that are initialized include a hardware timer 1 150, timer 2 151, and an external interrupt 147. External interrupt 147 is the input coming from reflective opto-sensor 111 that will tell the software a revolution of display assembly 103 has completed. Hardware timer 1 150 will be responsible for tracking the duration of a revolution as was explained earlier, and timer 2 151, will track the duration of pixel columns as will be explained later.

Processing continues with step 156 which checks to see if six pixel column shifts have occurred. On the first pass the yes path will be taken, and then processing continues with step 157. In step 157 the software will move to the first character of message 136 and load the corresponding character pixel map 145 into character buffer 142 (FIG. 1F). Processing continues with step 158 where all of the pixel columns in memory will be moved to the left to scroll message 136 as was explained above. Once the pixel data is shifted in memory, processing continues with 159 where a 30 ms delay is executed. The delay is necessary to slow the speed of the scrolling message to a rate that is readable.

Processing returns to step 156 where a check is performed to see if six pixel shifts have occurred. If less than six pixel shifts have occurred, processing continues with step 158. Six shifts are necessary to move the contents of character buffer 142 into display memory 141. Note that the character pixel maps 145 are five pixels wide and that a pixel column is left blank to allow for spaces between character maps 145. After six iterations of shift step 158, processing returns to step 157 in which a new character is loaded into character buffer 142. Message 136 continues to scroll through display memory 141 over and over in an unending loop.

Referring now to FIG. 1I, a completed revolution interrupt service routine 700 that measures the revolution period of display assembly 103 (FIG. 1A), is discussed. Processing starts with step 160, which is executed each time reflective opto-sensor 111 activates external interrupt 147 of microcontroller 108. Processing continues with step 161, which saves the display assembly 103 revolution time value that is currently on hardware timer 1 150 of microcontroller. Processing then continues with step 162, in which hardware timer 1 150 is reset so that it can begin tracking the time for the next revolution. Processing continues with step 163, in which a pixel column pointer 146 (FIG. 1F) is reset to the first column, the importance of which will be explained below.

Processing then continues with step 164, which performs the critical task of calculating the length of time that led array 104 will display each column of pixel data from display memory 141 so that all 128 columns are displayed once during one revolution of display assembly 103. This length of time calculation is the duration of the previous revolution saved in step 161 divided by 128. The result of this calculation, which is called the column display time, will be used later in a pixel column data interrupt 800 shown in FIG. 1J. Processing continues with step 165, where interrupt service routine 700 ends and returns control to software program 600.

Continuing now with FIG. 1J, the pixel column interrupt service routine 800 is shown. This block of code is responsible for copying pixel data from the display memory 141 to the LED array 104 at specifically timed periods in order to paint the image in the display memory 141 along the revolution path 139 (FIG. 1E). Processing begins with step 166, which is called when hardware timer 2-151 of microcontroller 108 times out and activates the internal interrupt. Processing continues with step 167, in which the column display time (calculated in step 164) is loaded onto timer 2 151, thus resetting the timer. The hardware timer reset will then begin the count down that will trigger another interrupt after the column display time has elapsed. Note that the hardware timers 150 and 151 are able to count down in the background wile the processor 148 continues to run software.

Processing continues with step 168, which will load LED array 104 with data from display memory 141 at the location pixel column pointer 146 is pointed to. This data is loaded to microcontroller output port 149 which will light LED array 104 accordingly. Continuing to step 169, in which pixel column pointer 146 is incremented so that the adjacent column will be loaded the next time this interrupt is called.

As was mentioned earlier, pixel column pointer 146 is reset to point to first column 143 each time the completed revolution interrupt routine 700 of FIG. 1I is called. This is important because it keeps column one 143 pinned to the physical location of reflective tab 112 (FIG. 1A). Otherwise the displayed column one 143 position would begin to float sporadically relative to reflective tab 112. Processing continues with step 170, where pixel column data interrupt 800 completes and returns processor 148 control to the main software loop 600. Pixel column data interrupt service routine 800 is called for each column of the message in display memory 141. This means that on each revolution of display assembly 103, interrupt service routine 800 outlined in FIG. 1J will update the data in LED array 104 128 times.

A USB interrupt service routine 900 shown in FIG. 1K, which is intended to service a USB host in order to download personalized messages 136 from a personal computer 174 (FIG. 1L), is now discussed. Processing begins at step 171, which is called when microcontroller USB external interrupt 153 detects that a USB cable 176 and a USB host 174 (FIG. 1L) is connected to USB data connection point 109. Upon detection processing continues with step 172, in which microcontroller 108 responds to the specific request of the USB host 174 (FIG. 1L). The host will tell microcontroller 108 to save message 136 in a flash memory location 152. When the USB host is done transferring the message 136 it releases control of microcontroller 108 and processing continues at step 173 where USB interrupt service routine 900 ends and control is returned to the main loop 600.

To setup first preferred embodiment of message display balloon 100, a user will first have to program message 136 into message display assembly 103. Referring to FIG. 1L, the user will connect USB cable 176 to the USB data connection point 109 on display assembly 103. The other end of USB cable 176 will be connected to a computer USB host 174. Then with the help of software with a graphical user interface 175 the user will be able to create a personalized message 136 and upload that message to the microcontroller 108 flash memory.

FIGS. 1M through 1P show the steps that are needed to properly install balloon 101 onto balloon support 118. Starting with FIG. 1M, balloon 101 and the rest of the device are initially separated. Note that rotating arm 107, being made of flexible material, is bent down so that display assembly 103 may pass through balloon opening 119. As shown in FIG. 1N, the user will gently slide balloon 101 over display assembly 103 and down past support clip 117. Note in FIG. 1N that balloon support 118 is slid down outer concentric tube 114 allowing for room to slide balloon opening 119 into place.

Continuing with FIG. 1O, it can be seen that balloon support 118 has been slid up outer concentric tube 114, and the balloon opening 119 has been fed through balloon support 118. Note also in FIG. 1O that balloon support 118 is not yet clipped into support clip 117. A helium delivery hose 177 being fed by a helium tank 178 is used to fill balloon 101 with helium. Note that in FIG. 1O, display assembly 103 is still deformed out of shape, even after balloon 101 has been filled with helium 102.

Moving on to FIG. 1P, after balloon 101 has been filled, it can be seen that balloon support 118 has been slid the rest of the way up balloon opening 119 until it clipped to support clip 117, thus sealing balloon opening 119 shut. Motor switch 132 may now be switched on, so that electric motor 127 begins to spin, and spinning display assembly 179 has been forced out of its previous deformation by centripetal force.

With display assembly 179 spinning, software program 600 on microcontroller 108 (FIG. 1A) will start displaying pre-programmed message 136, as can be seen in FIG. 1B. Message 136 in this embodiment will scroll from right to left and, existing on a cylindrical medium in space, will originate from, and end before, first pixel column 143 explained earlier. Message 136 will continue to scroll over and over until motor switch 132 (FIG. 1A) is turned off. With all of the functionality explained in this embodiment of the message display balloon 100, a user will be able to create a personalized message and, for example, give this device to a significant other, or use it for a special occasion.

It should be noted that even though a scrolling message was specifically disclosed in this first preferred embodiment the software of microcontroller's 108 software could be modified to support any graphic that can be displayed by the persistence of vision 140 display medium.

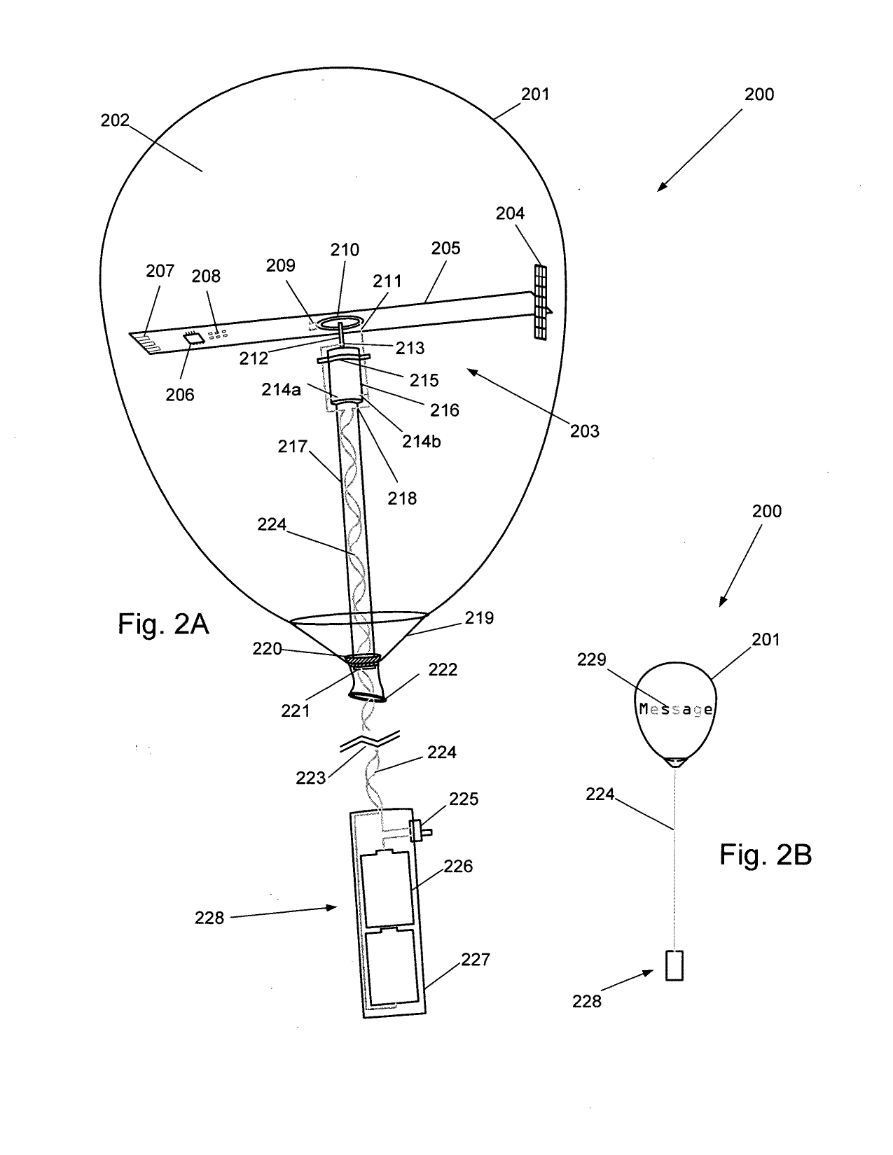

Referring now to FIGS. 2A and 2B, a second preferred embodiment of a message display balloon 200 is disclosed. Message display balloon 200 is comprised of a balloon 201 filled with helium 202 and a message display assembly 203 contained within balloon 201. Display assembly 203 is further comprised of a rotating arm 205 that is supported by an electric motor 216 which is, in turn, supported by an assembly support tube 217.

Rotating arm 205 is a flexible printed circuit and is able to bend to extreme angles without breaking. Mounted at one end of rotating arm 205 is an RGB (Red Green Blue) LED array 204. In the second embodiment of message display balloon 200, RGB LED array 204 has seven separate LED components each with the ability to display the colors Red, Green, and Blue. A microcontroller 206 is connected to rotating arm 205 at the end opposing RGB LED array 204. In close proximity to microcontroller 206 is a USB data connection point 207, and discrete electronic components 208.

Rotating arm 205 is mounted to an electric motor shaft 212 and is free to spin. Also connected to rotating arm 205, and encircling electric motor shaft 212, is a contact ring 210. A contact ring brush 211 touches contact ring 210, and is free to slide along the surface of contact ring 210 while conducting electricity as rotating arm 205 spins. A clocking contact 209 is mounted in close proximity to contact ring 210, and is on the same side of rotating arm 205 as microcontroller 206. Clocking contact 209 is a horseshoe shaped bare wire that extends down and away from rotating arm 205, thereby forming an electrical path for contact ring brush 211. As rotating arm 205 revolves there is a point where contact ring brush 211 will contact both contact ring 210 and clocking contact 209. A shaft brush 213 is touching electric motor shaft 212 and is free to slide on motor shaft 212 while electric motor 216 is spinning.

Mounted to electric motor 216 is a brush support 215, which holds contact ring brush 211 and shaft brush 213 in place. Electric motor 216 is mounted to assembly support tube 217, and both assembly support tube 217 and electric motor 216 are not free to spin. Inside of assembly support tube 217 are a set of power wires 224. Power wires 224 are soldered at one end to contact ring brush 211, and shaft brush 213, and run down through a support tube wire penetration 218 to a sealed wire penetration 221 at the bottom of the support tube 217. Power wires 224 then extend to a base 228 which will be explained below. Power wires 224 are also soldered to the positive 214a and negative 214b of electric motor 216.

A support clip 220 is glued to the bottom of assembly support tube 217. A balloon opening 222 passes over the outside of support clip 220, and through a hole in the bottom of a balloon support 219. Balloon support 219 seals off balloon opening 222 when clipped on to support clip 220. Support clip 220 holds display assembly 203 in a position centered relative to balloon 202. The distance between balloon 202 and base 228 is an arbitrary length and this is depicted in FIG. 2A at 223. Base 228 consists of a case 227 that contains a set of batteries 226 and a switch 225.

Display assembly 203, electric motor 216, support tube 217, support clip 220 and balloon support 219 are all of a predetermined weight and dimension such that they will allow balloon 201 to maintain positive buoyancy while filled with helium 202.

Referring now to FIG. 2B, the operation of the second preferred embodiment of message display balloon 200, which displays a multicolored alphanumeric display or a graphic 229, is shown. In this figure balloon 201 is floating with a message 229 visible to the human eye inside. Balloon 201 is restrained from floating away by motor power wires 224 tethering the weight of base 228. The method for generating message 229 inside of balloon 201 is very similar to the method that was used in the first preferred embodiment. Because of this only the key differences between the first and second embodiment will be discussed in this section.

Returning to FIG. 2A, all of the components of the second embodiment of the message display balloon 200 are shown. RGB LED 204 mounted to the end of rotating arm 205 gives the second embodiment the ability to display message 229. RGB LED array 204 serves the same function that the array in the first embodiment, but in the second embodiment each LED is able to display red, green, and blue. These three colors can be combined to create many combinations of colors, and therefore provides more options for generating text and graphics.

The distribution of power is another key difference that is seen in the second preferred embodiment. Here, there is one set of batteries 226 located in base 228 that provides power to both electric motor 216 and discrete electronic components 208. Because electric motor 216 is located inside of balloon 201 in this embodiment, power wires 224 become the only component that is tethering balloon 201 to base 228. Power wires 224 pass up through a sealed wire penetration 221, which provide a helium 202 tight barrier thus keeping balloon 201 inflated. Electric motor 216 is directly connected to power wires 224 at its positive 214a and negative 214b terminals. Power wires 224 then continue upward and are soldered to contact ring brush 211 and shaft brush 213.

These two brushes 211 and 213 are the physically touching contacts that will provide power to all of the electronic components on display assembly 203 while it is spinning. Contact ring brush 211 will slide along the surface of contact ring 210 through the entire 360° revolution of rotating arm 205. In the same way, shaft brush 213 will slide along the surface of electric motor shaft 212 through the entire 360° revolution of rotating arm 205. Electric motor shaft 212 has an electrically conductive connection to discrete electronic components 208 on rotating arm 205, and is assumed to be electrically isolated from the rest of electric motor 216. This isolation is important; otherwise short circuit current could exist between electric motor shaft 212 and negative motor terminal 214b.

The method for providing power to discrete electronic components 208 on the rotating arm 205 that is depicted in the second preferred embodiment allows for the rotation clocking to be implemented in a different way. Because contact ring brush 211 is stationary relative to rotating arm 205, the former can be used as a source of reference for clocking. This is done by adding a clocking contact 209 that will touch contact ring brush 211 once per revolution. With this design, microcontroller 206 will be able to detect the time it takes for a single revolution of rotating arm 205, and display timing calculations will be made accordingly.

Operation of the second preferred embodiment is substantially the same as the first embodiment that was explained earlier. Display assembly 203 can be programmed to show customized messages or graphics, and then the balloon can be inflated and sealed. When the setup for this embodiment is complete, switch 225 can be turned on and message 229 will be displayed inside of floating balloon 229.

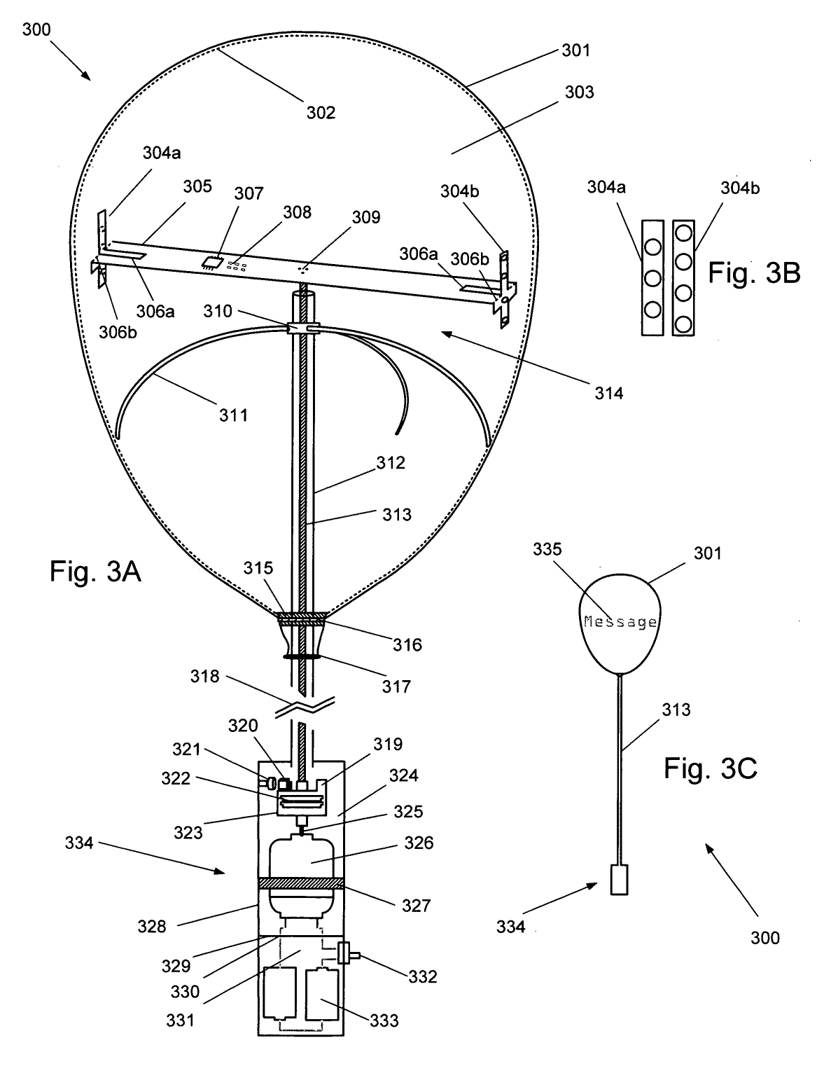

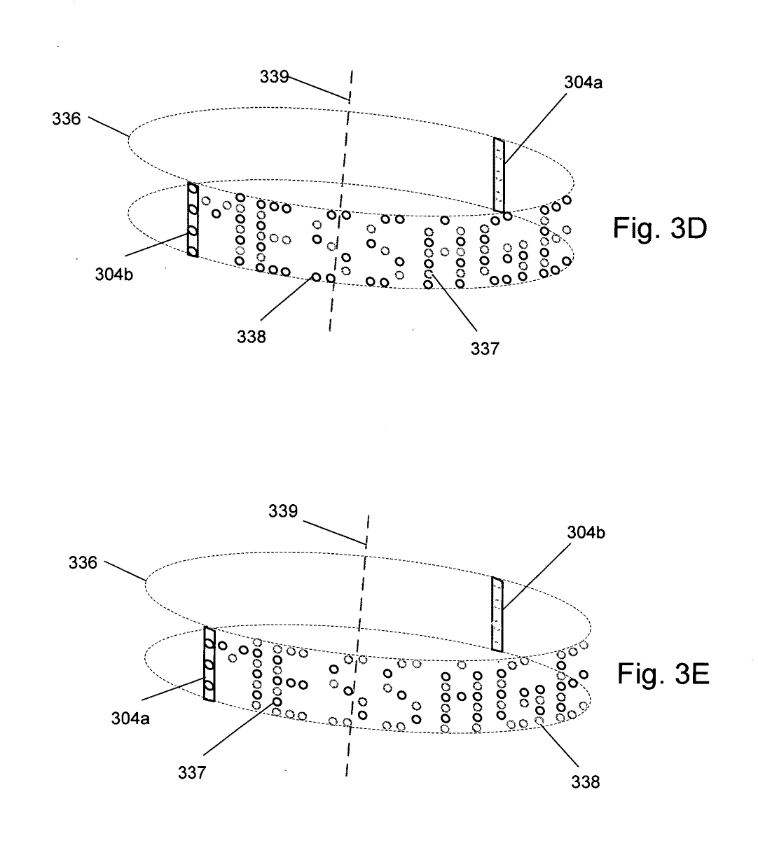

FIGS. 3A, 3B, and 3C show a third preferred embodiment 300 of the present invention, comprised of a balloon 301 filled with helium 303. The inner surface of balloon 301 is coated with a florescent powder 302. Inside of balloon 301 is a display assembly 314 that includes all of the electronic components that are attached to a rotating arm 305. Rotating arm 305 is a flexible circuit board that has wire traces routing power and signals on the rotating arm 305, which will be explained below.

Each end of rotating arm 305 has a laser UV LED array 304a and 304b. The array supports are actually a continuation of the same flexible circuit board that makes up rotating arm 305. Arrays 304a and 304b are created by cutting rotating arm 305 at 306a and then folding the flexible circuit 90 degrees at 306b so that it is perpendicular to rotating arm 305.

One of the arrays is designated as an even row laser UV LED array 304a, and it has three UV LEDs that are evenly spaced out with the width of a UV LED separating them. The other array is designated as an odd row laser UV LED array 304b, and it has four UV LEDs that are evenly spaced and also have the width of a UV LED separating them. FIG. 3B shows the two UV LED arrays, 304a and 304b side by side, and it can be seen that the UV LEDs are spaced out such that there is a UV LED for each space in the adjacent array.

Attached to rotating arm 305 are a microcontroller 307 and a set of discrete electronic components 308. Microcontroller 307 and discrete electronic components 308 are deliberately placed on the side of rotating arm 305 that is opposite of even laser UV LED array 304b, a distinction made for weight balance while rotating. Display assembly 314 is mounted on a three conductor wire 313 by a set of three solder joints 309. The three conductors inside of wire 313 lead down to a base 334 to a set of logic batteries 322 and to a Hall Effect sensor 320 (explained later).

Three conductor wire 313 is inside of a tube 312 that leads from base 334 up to just below display assembly 314. Near the top of tube 312 is a balloon support 310 that has three support arms 311 that extend radially outward from tube 312 120 degrees apart from each other. Each support arm 311 extends out to balloon 301 and exerts a small force to hold tube 312 centered relative to balloon 301.

Further down tube 312 is a seal clip 315 which is a circular disk mounted coaxially and outside of tube 312. Seal clip 315 has a channel cut around its outside edge which makes it similar in shape to a rope pulley. Balloon neck 317 passes over the outside of seal clip 315. A rubber band 316 is slid over the outside of balloon neck 317 until it seals balloon 301 by constricting it into the channel in seal clip 315.

All of the components inside of and hanging from balloon 301; including display assembly 314, balloon support 310, seal clip 315, three conductor wire 313, and tube 312, but not including the components in base 334, are of a predetermined weight and dimension such that they will be light enough for balloon 301 to float while filled with helium 303. Tube 312 and three conductor wire 313 are of an arbitrary length 318 as long as they do not add enough weight to prevent balloon 301 from floating.

Base 334 is divided into two compartments, the first is a pressurized chamber 324 and the second is an un-pressurized chamber 331. These two chambers are enclosed by base wall 328 and are divide by chamber dividing wall 329. Pressurized chamber 324 is a continuation of the same volume inside of balloon 301 that is linked by tube 312. Inside of pressurized chamber 324 are an electric motor 326 and a rotating battery case 323 that is mounted on electric motor shaft 325. Three conductor wire 312 is mounted to rotating battery case 323 coaxially. Display assembly 314, three conductor wire 312, rotating battery case 323, and motor shaft 325 are all mounted in line with each and are free to spin relative to base 334.

Hall Effect sensor 320 is mounted to the top of rotating battery case 323 and is in line with a permanent magnet 321 that is mounted to base wall 328. On rotating battery case 323, opposite of Hall Effect sensor 320, is a counter weight 319 formed into the rotating battery case 323 which is placed to counter the centripetal force of Hall Effect sensor 320 during rotation. As mentioned briefly before two of the conductors of three conductor wire 313 lead to the logic batteries and are used to power the display assembly 314. The third conductor is wired to the Hall Effect sensor 320.

Electric motor 326 is mounted to base 334 by a motor support clip 327. Motor power wires pass through chamber dividing wall 329 via a sealed wire penetration 330. Inside of un-pressurized chamber 331 are a pair of motor batteries 333 and the wires that supply power to electric motor 326. Mounted in base wall 328 is a motor power switch 332 that switches motor power supplied by motor power batteries 333.

The operation of the third preferred embodiment is now discussed with references to FIGS. 3A-3E. In this embodiment, a factory loaded message or graphic 335 is displayed on the inside surface of balloon 301. There are many similarities between this embodiment and the first preferred embodiment, and because of this only the key functional differences between the two designs will be described here.

In the third preferred embodiment there are two LED arrays 304a and 304b that complement each other in the function of generating the persistence of vision message 335. FIG. 3B shows the two UV LED arrays 304a and 304b side-by-side, demonstrating the how the LEDs are offset such that there is an LED for each horizontal row. In other words, if the two LED Arrays 304a and 304b were placed on top of each other they would create one contentious column of laser UV LEDs. With this configuration it is possible to generate a message or graphic through the persistence of vision effect, as is shown in FIGS. 3D and 3E. It should be noted that this complementary array design makes display assembly 314 more symmetrical thus reducing centripetal balance constraints.

Referring specifically to FIG. 3D, odd row laser UV LED array 304b is shown traveling along a path 336 directly across from even row laser UV LED array 304a. It can be seen that odd row laser UV LED array 304b is responsible for generating the odd row persistence of vision effect 338 on rows 1, 3, 5, and 7 while it takes its path 336 around the axis of rotation 339. The light grey circles in FIG. 3D represent the even row persistence of vision effect 337 that was generated by even row laser UV LED array 304a on the previous pass around the axis of rotation 339.

FIG. 3E shows the same message being generated after the two arrays 304a and 304b were allowed to travel 180° around the axis of rotation 339. Now even row laser UV LED array 304a is generating the even row persistence of vision 337 portion of the message on rows 2, 4, and 6. In FIG. 3E the light grey circles represent the residual odd row persistence of vision 338 portion of the message from odd row array's 304b previous path 336 around the axis of rotation 339.

Message 335 (FIG. 3C) displayed in this embodiment will appear on the inside surface of balloon 301. This is performed through an effect called fluorescence that will be known to those skilled in the art. When ultra-violate light emitted from the laser UV LED Arrays 304a and 304b hits fluorescent powder 302 on the inside wall of balloon 301, the invisible ultra-violate light is converted to visible light. This converted visible light will form message 335 that will be seen at the surface of balloon 301.

In the third preferred embodiment, the clocking of each revolution of display assembly 314 is tracked with the use of a Hall Effect sensor 320 and a permanent magnet 321. Hall Effect sensor 320 is capable of digitally detecting the presence of a magnetic field, which is relayed back to microcontroller 307 via one of the conductors in three conductor wire 313. Each time rotating battery case 323 makes a revolution Hall Effect sensor 320 will detect when permanent magnet 321 passes by its stationary position on base wall 328. When electric motor 326 is turned on and settles at a near constant speed the Hall Effect sensor 320 will detect each revolution and microcontroller 307 and will use that information to calculate the time period for each revolution.

Balloon support 310 is implemented differently in this third preferred embodiment, but still provides the same function of preventing display assembly 314 from touching balloon 301 due to oscillations cause by the rotating display assembly 314.

Operation of the third preferred embodiment only involves installing and inflating balloon 301 over display assembly 314. Because message 335 is preloaded in this embodiment, there is not an uploading step. The operator will have to first bend rotating arm 305 (which is made of flexible circuit material). The operator will then slide the balloon neck 317 over display assembly 314, and then over seal clip 315 while making sure that rubber band 316 is just below seal clip 315 ready for use. Balloon 301 will then be inflated using helium 303 and balloon 301 will be sealed shut by placing rubber band 316 over balloon neck 317 constricting it round seal clip 315. The operator will then turn on motor power switch 332 which will power up motor 326, and accelerate display assembly 314 to a stable rotational speed. Microcontroller 307 will then begin to run through the message software and will turn on and off individual UV LEDs in LED arrays 304a and 304b according to the message that it is to display. UV LED arrays 304a and 304b will shine ultra-violet light on the fluorescent powder and visible light organized into message 335 will be visible on the surface of balloon 301.

The foregoing description includes what are at present considered to be preferred embodiments of the invention. However, it will be readily apparent to those skilled in the art that various changes and modifications, may be made to the embodiments without departing from the spirit and scope of the invention. For example, the type of microcontroller and electronic components may be changed. Accordingly, it is intended that such changes and modifications fall within the spirit and scope of the invention, and that the invention be limited only by the following claims.

What is claimed is:

1. A dynamic messaging system, comprising:
a balloon containing a volume of helium, said volume of helium having a bouyancy depending on said volume;
a light-emitting diode array disposed within said balloon, said light-emitting diode array further comprised of a plurality of light-emitting diodes, and said light-emitting diode array having a predetermined weight, and said predetermined weight capable of being lifted by said bouyancy of said volume of helium;
a power source connected to said light-weight light emitter array; and
means for rotating said light-weight light emitter array within said balloon, said means for rotating connected to said LED array and to said power source;
whereby said light-weight light emitter array provides a display medium inside said balloon and is of a predetermined weight to be light enough for said balloon to retain positive bouyancy.

2. The dynamic messaging system of claim 1, wherein said light-emitting diode array further comprises:
a rotating arm connected to said light-emitting diode array, said rotating arm for moving said light-emitting diode array along a circular path within said balloon.

3. The dynamic messaging system of claim 1, wherein said plurality of light-emitting diodes generate light in a plurality of colors in a visible frequency range.

4. The dynamic messaging system of claim 1, wherein said plurality of light-emitting diodes generate light in the UV spectrum, and said balloon includes an inner surface coated with a flourescent material, whereby invisable light from said UV laser LEDs will project on to said flouresent material causing it to flouress, allowing visable light to be seen at the surface of said balloon.

5. The dynamic messaging system of claim 2, wherein said rotating arm further comprises a microcontroller for controlling said LED array.

6. The dynamic messaging system of claim 5, further comprising a stored software program for providing instructions to said microcontroller.

7. The dynamic messaging system of claim 6, further comprising means for programming said stored software program.

8. The dynamic messaging system of claim 1, wherein said power source comprises a battery.

9. The dynamic messaging system of claim 1, wherein said means for rotating comprises an electric motor.

10. A dynamic messaging system, comprising:
a balloon containing a volume of helium, said volume of helium having a bouyancy depending on said volume;
a plurality of light-emitting diode arrays disposed within said balloon, each of said plurality of light-emitting diode arrays further comprised of a plurality of light-emitting diodes, and said plurality of light-emitting diode arrays having a predetermined weight, and said predetermined weight capable of being lifted by said bouyancy of said volume of helium;
a power source connected to said low plurality of light-weight light emitter arrays; and
means for rotating said plurality of light-weight light emitter arrays within said balloon, said means for rotating connected to said plurality of light-weight light emitter arrays and to said power source;
whereby said plurality of light-weight light emitter arrays will provide a display medium inside said balloon and is of a predetermined weight to be light enough for said balloon to retain positive boyancy, furthermore a plurality of light-weight light emitter arrays can be distributed such that when rotated by said means for rotating their centriptal force componets are balanced.

11. The dynamic messaging system of claim 10, wherein said plurality of light-weight light emitter arrays further comprises:
a plurality of rotating arms connected to said plurality of light-weight light emitter arrays and to said means for rotating, said plurality of rotating arms for moving said plurality of light-weight light emitter arrays along a circular path within said balloon.

12. The dynamic messaging system of claim 10, wherein said plurality of light-weight light emitters generate light in a plurality of colors in a visible frequency range.

13. The dynamic messaging system of claim 10, wherein said plurality of light-weight light emitters generate light in the UV spectrum, and said balloon includes an inner surface coated with a flourescent material, whereby invisable light from said UV laser LEDs will project on to said flouresent material causing it to flouress, allowing visable light to be seen at the surface of said balloon.

14. The dynamic messaging system of claim 11, wherein said plurality of rotating arms further comprises a microcontroller for controlling said LED array.

15. The dynamic messaging system of claim 14, further comprising a stored software program for providing instructions to said microcontroller.

16. The dynamic messaging system of claim 15, further comprising means for programming said stored software program.

17. The dynamic messaging system of claim 10, wherein said power source comprises a battery.

18. The dynamic messaging system of claim 10, wherein said means for rotating comprises an electric motor.

19. In dynamic messaging system comprising a balloon containing a volume of helium having a bouyancy depending on said volume, a light-emitting diode array disposed within said balloon, said light-emitting diode array further comprised of a plurality of light-emitting diodes, and means for rotating said light-weight light emitter array within said balloon, said means for rotating connected to said LED array and to said power source:
said light-emitting diode array further comprising a predetermined weight capable of being lifted by said bouyancy of said volume of helium, whereby said light-weight light emitter array provides a display medium inside said balloon and is of a predetermined weight to be light enough for said balloon to retain positive bouyancy.
